(19) United States
(12) Patent Application Publication
(10) Pub. No.: US 2019/0184512 A1
(43) Pub. Date: Jun. 20, 2019

(54) A MACHINE HAVING A CLEANING DEVICE AND OPTICAL MEASURING DEVICE

(71) Applicant: Thielenhaus Technologies GMBH, Wuppertal (DE)

(72) Inventor: Thomas Schmitz, Wermelskirchen (DE)

(21) Appl. No.: 16/331,232

(22) PCT Filed: Sep. 6, 2017
(86) PCT No.: PCT/EP2017/072350

§ 371 Date: Mar. 7, 2019

(30) Foreign Application Priority Data
Sep. 8, 2016 (DE) 10 2016 116 816.5

(51) Int. Cl. B23Q 17/24; B23Q 11/00; B23Q 39/04; B24B 27/00; B24B 35/00; B24B 49/12

(52) U.S. Cl. CPC B23Q 17/2471; B23Q 11/0075; B23Q 39/042; B24B 49/12; B24B 27/0069; B24B 35/00; B24B 27/0023

(57) ABSTRACT

A machine for machining workpieces includes a movably mounted table (1) and at least one clamp (2). Each clamp is engageable with a workpiece and can be rotatably driven relative to the table. Each workpiece is transportable by movement of the table to a first workstation (3). Workstation 3 includes a toolholder (4) that holds a tool that is operative to machine a surface of the workpiece. The toolholder is movable in engagement with the workpiece by a feed unit (5) and the orientation of the tool holder relative to the workpiece is changeable by movement of an alignment unit (6). A second workstation to which the workpiece is moved after machining includes a cleaning device (8). A third workstation to which the workpiece is moved after cleaning includes a measuring device (10) that optically determines at least one surface property of the machined surface. The measuring device is in connection with an evaluation unit (14). The evaluation unit evaluates the at least one surface property and determines a direction and an order of magnitude that the alignment unit must be adjusted so at least one subsequently machined workpiece meets required tolerance specifications.

### BACKGROUND

The exemplary embodiments relate to a machine for processing work pieces, comprising at least three stations and having a movably mounted table, wherein at least one in particular rotationally drivable clamping device for clamping a workpiece is arranged on the table and the clamped workpiece can be transported into the working regions of the stations by movement of the table, wherein a first station is designed as a machining station for machining a surface of the workpiece, in which a tool holder holding the tool for machining the workpiece is arranged in a rotationally drivable manner, wherein the tool holder can be advanced to the workpiece by a feed unit and is mounted such that the tool can be aligned with respect to the workpiece by an alignment unit.

Such a machine is known from DE 100 16 897 B4 which is incorporated herein by reference in its entirety. When during the machining the tool is driven in a rotating manner about an axis and also the workpiece is driven in a rotating manner about an axis, this is also referred to as end processing or finishing, which is known in particular as microfinishing or superfinishing. Since the requirements for shape and dimensional tolerances are very high, when the machine is set up to produce which is also referred to herein as “run in” for a new workpiece batch, a first workpiece of the batch is finish-machined/end-processed with the machine, wherein further pre-machining steps can also take place at other stations of the machine. In order to determine the surface property of the finish-machined (or end processed) outer surface of the workpiece, the workpiece has to be removed from the clamping device. The surface property, such as planarity or roughness, can be determined following removal from the clamping device by using a white light interferometer. The experienced machine operator can recognize from the interference image, in which direction the alignment unit has to be manually adjusted (if necessary) in a linear or rotatory manner, in order to come closer to the specified tolerance during the machining of the next work piece or to comply with the specified tolerance during the machining of the next work piece. For example, the planarity of the finish-machined surface of the workpiece can be examined for its slight concave or convex curvature specified by the tolerance, such that the angle of attack of the tool relative to the workpiece is changed in dependence on the interference image.

Since the interference image of the finish-machined surface is rendered inaccurate by the smallest contaminations, the finish-machined surface is cleaned by chemical solvents to remove coolant and/or lubricant residues before the optical measurement. Since, on the one hand, the relatively expensive white-light interferometer is used in parallel to run in a plurality of machines, and the interferometer can be used only by specially trained personnel and, on the other hand, a plurality of workpieces of a batch have to be machined during run in until the specified tolerances are met, it can occur, that running in a machine for production of a batch of a new workpiece batch lasts up to several days. The known machines therefore have relatively long standstill times when running in new workpiece batches.

### SUMMARY

Useful features of the described example embodiments solve the problems described with reference to the prior art and in particular to specify a machine, which is provided faster for the continuous production of a new work piece batch.

Such useful features may be achieved by a machine and a method having the features of the independent claims. Further useful features of the machine and of the method are specified in the dependent claims and in the description, wherein individual features of the example embodiments can be combined with one another in a technologically meaningful manner.

Useful features may be achieved in particular by a machine having the features mentioned at the outset, wherein a second station has a cleaning device for removing coolant and/or lubricant residues from the finish-machined surface, and wherein a third station has a measuring device for optically determining at least one surface property of the finish-machined and cleaned surface of the workpiece, wherein the measuring device is connected to an evaluation unit, which evaluates the optically determined surface property and which specifies on the basis of the evaluation, by which extent the alignment of the tool holder has to be readjusted by the alignment unit in order to comply with the specified tolerances.

The exemplary arrangement is thus associated with the advantage that the surface property of the finish-machined surface of the workpiece can be determined directly in the machine, wherein it is ensured on the basis of the cleaning device that the measurement result is not rendered inaccurate by contamination. Since the evaluation unit also specifies the direction in which the workpiece holder must be adjusted for the machining of the next workpiece, the machine can also be run in by untrained personnel.

The exemplary movably mounted table is in particular a round table which can be driven in a rotatory manner, so that the particular several clamping devices describe an arc-shaped path during the movement of a workpiece from one station to the next station that is disposed from the prior station. The workpiece therefore has to be clamped only once into the clamping device to undergo machining, cleaning and measurement in the machine.

The exemplary clamping devices (i.e. clamp or chuck) can be driven, in particular each, in a rotating manner. Accordingly, a drive for the clamping devices is provided.

In addition, in an exemplary arrangement a drive for the tool holder can be provided, which drives the tool holder in order to move the tool holder in engagement with the workpiece during the finish machining of the workpiece in the station. In particular, the tool holder can be driven either in a linear oscillating movement or in a rotational movement about the tool holder axis. If the clamping device is rotationally driven to move the workpiece and also the tool holder is driven to move the tool during machining, this is called a finishing treatment which is also known as microfinishing and superfinishing.

While the exemplary tool holder can be advanced in particular linearly to the workpiece clamped in the clamping device by the feed unit, the tool holder can be set by the exemplary alignment unit as to how the tool holder is aligned in the fed position with respect to the workpiece. In particular, the alignment can be achieved by linear displacement along the three directions in space as well as by pivoting around up to three mutually orthogonal pivot axes. In principle, the alignment of the tool holder can be affected manually.

The exemplary feed unit comprises, in particular, an electrically drivable slide for delivering the tool holder to the workpiece.

The exemplary cleaning device of the second station is configured in such a way, that the residues of the coolant and/or lubricant agents applied during the finish machining are removed from the finish-machined surface of the workpiece. For this purpose, in particular, it can be provided that the second station is separated from adjacent stations by separating means, for example movably mounted dividing walls, so that contamination of the other stations by the cleaning agent is prevented. Since chemical solvents cannot only interfere with the finish machining process but can also attack machine elements, it has hitherto been possible to integrate cleaning devices only at a distance from the machine elements into machines for finishing work pieces.

In particular, the exemplary cleaning device therefore uses no chemical solvents as a cleaning agent. The cleaning device preferably comprises means for producing a carbon dioxide (CO₂) snow jet, i.e. a carbon dioxide snow nozzle. The at least one CO₂ snow jet removes the coolant and/or lubricant residues without changing the finish-machined surface.

Alternatively, the exemplary cleaning device can comprise a laser by which the coolant and/or lubricant residues can be evaporated.

The exemplary cleaning device can comprise, in particular, elements (i.e. movable walls) which can be moved into a position enclosing the workpiece in order to form a chamber, in which the CO₂ snow jet or the laser beam is introduced. At this element(s) forming the chamber, either the laser or the nozzle for generating the CO₂ snow jet can be arranged. In the case of processing with CO₂, an extraction device for the evaporated CO₂ can also be provided on the chamber.

The exemplary optical measuring device comprises in particular a light source which emits light in the direction of the finish-machined surface. The measuring device further comprises a sensor which detects at least the light reflected from the finish-machined surface. In particular, the exemplary measuring device comprises an interferometer, preferably a white light interferometer. The (interference) image captured by the sensor thus indicates the surface property of the finished surface. The surface property can thus be determined without mechanical action on the finish-machined surface.

From the image captured by the exemplary sensor, in particular the planarity and/or roughness of the surface can be determined by means of known methods. The surface property detected by the optical measuring device can be stored for each machined workpiece by integrating the measuring device into a station of the machine, so that a control of the quality of the machining is possible for all workpieces processed.

The exemplary evaluation unit is set up in such a way that it can specify, for example, on the basis of the image captured by the measuring device, in which direction and about which order of magnitude the alignment unit has to be adjusted, so that the specified tolerances can be met for each of the subsequently machined workpieces. In this way, untrained machine technicians can readjust the alignment unit, in the ideal case immediately after the machining of the first workpiece, in such a way that all of the following workpieces adhere to the tolerances. At least, due to the immediate indication of the needed readjustment the completion of running in of the machine is accomplished after the machining of only a few workpieces is possible.

In particular, the exemplary evaluation unit compares the respectively captured workpiece surface properties (images) with theoretically predetermined or experimentally proven reference images, in order to be able to calculate on the basis thereof the degree of readjustment needed. It is thus also possible with the evaluation unit, after the first running in, to readjust the alignment unit between the machining of individual workpieces of a workpiece batch, so that even more narrow tolerances can be met.

In an example arrangement order to dispense with the step of manual readjustment, the alignment unit preferably comprises electrically controllable actuators, so that the alignment unit can be automatically readjusted depending on the surface properties evaluated by the evaluation unit. Such electrically controllable alignment units are viable for use in these machines because in the example arrangement the result of the surface analysis is present shortly after the finish machining.

The useful features and results mentioned at the outset are also achieved by an exemplary method for operating a machine for finishing a surface of a workpiece, comprising the following steps:
Machining, in particular finishing (also called end processing) the surface of the workpiece by an alignable tool in a first station of the machine,
Removing lubricant and/or coolant residues from the finish-machined surface in a second station of the machine,
Determining at least one surface property of the finish-machined and cleaned surface of the workpiece by means of an optical method in a third station of the machine,
Evaluating the optically determined surface property, and
Aligning the tool as a function of the evaluated optically determined surface property for machining another workpiece and/or storing the optically determined surface property.

In particular, in an example arrangement it is provided that the orientation, for example the angle of attack of the tool or the tool position relative to the workpiece is automatically changed as a function of the optically determined planarity of the surface. The machine can therefore accomplish run in itself.

The features and advantages disclosed with reference to the machine can be applied to the method and transferred and vice versa.

### BRIEF DESCRIPTION OF DRAWINGS

The example arrangements are explained in the following by way of example with reference to the Figures.

FIG. 1 is a top view of an exemplary machine, and

FIG. 2 is a longitudinal section through a measuring station of the exemplary machine.

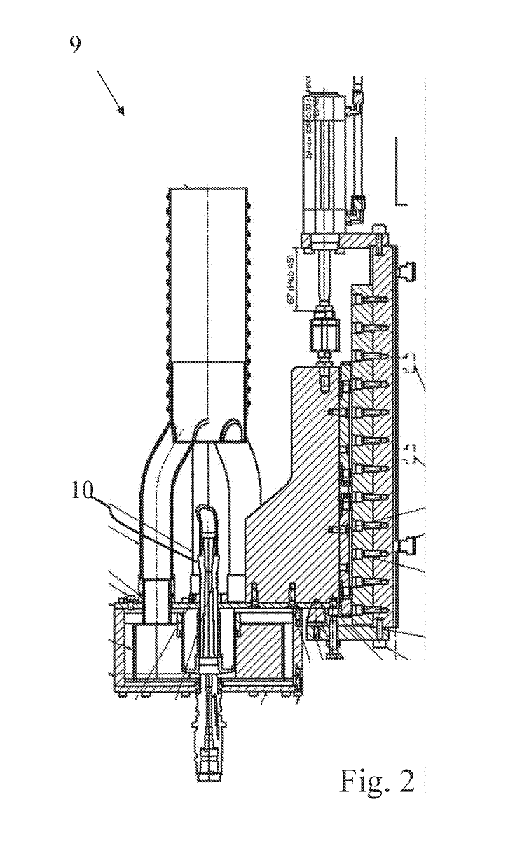

### DETAILED DESCRIPTION OF EXAMPLE ARRANGEMENTS

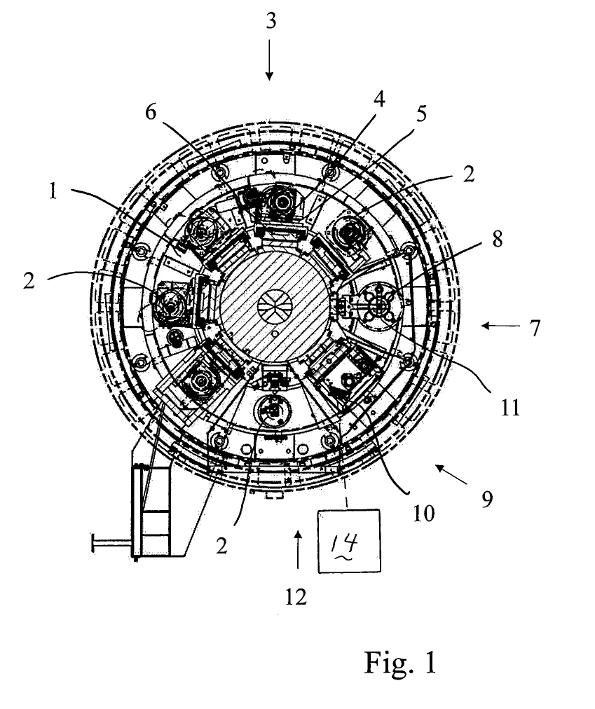

The machine shown in FIG. 1 comprises a table 1 designed as a round table, on which a plurality of clamping devices 2 which are alternatively referred to herein as clamps, are supported. The clamping devices 2 can each be brought to an adjacent station by rotating the table 1. In a loading station 12, a workpiece is clamped into the corresponding clamping device 2. Machining is carried out in the following stations, for example. In the station identified as the first station 3, a finish machining is then carried out, during which the clamping device 2 with the work piece fixed therein is driven in a rotatory manner. At the same time, a tool holder 4 holding the tool is rotationally driven relative to and in engagement with the rotating workpiece.

The tool holder 4 is fed linearly to the workpiece in the first station 3 by means of a feed unit 5, while the alignment of the tool holder 4 can be changed by an alignment unit 6.

Thereafter, the finish-machined workpiece is transferred in engagement with the clamping device 2 into a second station 7, that is disposed from the first station in which a cleaning device 8 is arranged. In example arrangements the second station 7 can be isolated from adjacent stations by suitable separating means. As can be seen the cleaning device 8 comprises a chamber 11 which can be closed above the workpiece. In the chamber 11, a CO₂ jet is directed onto the surface of the workpiece to be cleaned. The vaporized carbon dioxide is drawn off by an extraction device.

After the cleaning, the workpiece is transferred into a third station 9 that is disposed from the second station, in which a measuring device 10 is arranged. The exemplary measuring device 10 detects at least one surface property of the finish-machined and cleaned outer surface of the workpiece. This detected surface property can be stored. In addition, the exemplary measuring device 10 is connected to an evaluation unit 14, which includes circuitry that determines on the basis of the measurement result, the extent to which the alignment unit 6 of the first station 3 has to be readjusted in order to meet the specified tolerances for acceptable machined workpieces. For example, an angle of attack of the tool holder 4 relative to the workpiece can be changed, wherein the example evaluation unit 14 specifies, by which angle the alignment unit 6 has to be pivoted for the finish machining of a subsequent workpiece. When the alignment unit 6 can be operated electrically, the change in the orientation of the tool for the machining of a subsequent workpiece can also be carried out automatically.

Thus the example embodiments achieve improved operation, eliminate difficulties encountered in the use of prior devices and systems, and attain the useful results described herein.

In the foregoing description certain terms have been used for brevity, clarity and understanding. However, no unnecessary limitations are to be implied therefrom because such terms are used for descriptive purposes and are intended to be broadly construed. Moreover, the descriptions and illustrations herein are by way of examples and the new and useful features are not limited to the exact features show and described.

Further in the following claims any feature described as a means for performing a function shall be construed as encompassing any means known to those skilled in the art as being capable of carrying out the recited function, and shall not be deemed limited to the particular means shown or described for performing the recited function in the foregoing description or mere equivalents thereof.

Having described the feathers, discoveries and principals of the exemplary embodiments, the manner in which they are constructed and operated, and the advantages and useful results attained; the new and useful structures, devices, elements, arrangements, parts, combinations, systems, equipment, operations, methods, processes and relationships are set forth in the appended claims.

### LIST OF REFERENCE NUMERALS

1 Table

2 Clamping device

3 First station

4 Tool holder

5 Feed unit

6 Alignment unit

7 Second station

8 Cleaning device

9 Third station

10 Measuring device

11 Chamber

12 Loading station

14 Evaluation unit

1-10. (canceled)

11. Apparatus comprising:
a machine operative to machine workpieces that have associated required tolerance specifications that workpieces must meet after machining, the machine including
a table, wherein the table is rotatably movably mounted on the machine,
a clamp, wherein the clamp
is in operative connection with the table,
is operable to hold a workpiece in engaged relation with the clamp, and
is rotatably movable relative to the table,
wherein the table is rotatable to move the workpiece in engagement with the clamp to each of at least three disposed workstations on the machine,
wherein a first workstation includes
a tool, wherein the tool is operative to machine a surface of the workpiece at the first workstation,
a feed unit, wherein the tool is in operative connection with the feed unit, and wherein the feed unit is operative to move the tool relative to and in engaged relation with the workpiece at the first workstation,
an alignment unit, wherein the alignment unit
is in operative connection with the feed unit,
is movably mounted in operative connection with the machine,
wherein movement of the alignment unit is operative to change alignment of the tool relative to the workpiece at the first workstation,
wherein a second workstation to which the workpiece is moved by rotation of the table after being machined by the tool at the first workstation, includes
at least one of the laser and a CO₂ snow jet, wherein the at least one of the laser and the CO₂ snow jet is operative to clean the workpiece at the second workstation to remove at least one of coolant and lubricant residue,
wherein a third workstation to which the workpiece is moved by rotation of the table after the workpiece is cleaned at the second workstation, includes
a measuring device, wherein the measuring device is operative to determine an optical property of the machined surface of the workpiece,
an evaluation unit, wherein the evaluation unit
is in operative connection with the measuring device,
is operative responsive to the determined optical property to calculate at least one of a direction and an order of magnitude that the alignment unit needs to be adjusted for a subsequent workpiece that is machined through machine operation to comply with the required tolerance specifications.

12. The apparatus according to claim 11
wherein the alignment unit includes at least one electrically controllable actuator,
wherein the at least one electrically controllable actuator is operative to move the alignment unit responsive to the at least one calculated direction and order of magnitude.

13. The apparatus according to claim 11
wherein the feed unit comprises a slide.

14. The apparatus according to claim 11
wherein the feed unit comprises an electrically operable carriage.

15. The apparatus according to claim 11
wherein the second workstation comprises a nozzle, wherein the nozzle is operative to generate the CO₂ snow jet.

16. The apparatus according to claim 11
wherein the second workstation comprises a laser, wherein the laser is operative to produce a laser beam.

17. The apparatus according to claim 11
wherein the second workstation comprises a chamber,
wherein the chamber at least partially encloses the workpiece while it is cleaned by the at least one of the CO₂ snow jet and the laser.

18. The apparatus according to claim 11
wherein the measuring device comprises an interferometer, wherein the interferometer is operative to detect at least one of planarity and roughness of the machined surface.

19. The apparatus according to claim 11
wherein the measuring device comprises a white light interferometer.

20. The apparatus according to claim 11
wherein the measuring device is operative to determine at least one of planarity and roughness of the machined surface.

21. The apparatus according to claim 11
wherein the machine includes at least three clamps, and wherein each clamp is operative to engage a respective workpiece.

22. The apparatus according to claim 11
wherein the alignment unit includes at least one electrically controllable actuator,
wherein the at least one electrically controllable actuator is operative to move the alignment unit responsive to the at least one calculated direction and order of magnitude so as to change the angle of attack of the tool relative to the workpiece.

23. The apparatus according to claim 11
wherein the feed unit includes at least one of a slide and a carriage,
wherein the feed unit is in operative connection with a toolholder, wherein the toolholder is operative to hold the tool,
wherein the alignment unit includes at least one electrically controllable actuator operative to move the toolholder responsive to the at least one calculated direction an order of magnitude.

24. Apparatus comprising:
a machine operative to machine workpieces to required tolerance specifications,
the machine including
a table, wherein the table is movably mounted in operative connection with the machine,
a plurality of clamps,
wherein each of the clamps
is in operative connection with the table,
is disposed from each of the other clamps, and
is configured to hold a respective workpiece,
a plurality of workstations,
wherein the table is operative to move each clamp and a respective engaged workpiece sequentially through each of the plurality of workstations,
wherein the plurality of workstations includes a machining workstation,
wherein the machining workstation includes
a tool,
an electrical actuator, wherein the electrical actuator is in operative connection with the tool,
wherein the tool is moved relative to and in engagement with the workpiece at the machining workstation responsive at least in part to the electrical actuator to cause a surface of the workpiece to be machined,
wherein the plurality of workstations includes a cleaning workstation to which a workpiece is moved by the table through operation of the machine subsequent to the workpiece being machined in the machining workstation,
wherein the cleaning workstation includes at least one of a laser and a CO₂ snow jet which is operative to clean the workpiece at the cleaning workstation,
wherein the plurality workstations includes a measuring workstation to which a workpiece is moved by the table through operation of the machine subsequent to the workpiece being cleaned at the cleaning workstation,
wherein the measuring workstation includes an interferometer,
wherein the interferometer is operative to sense at least one property of the machined surface of the workpiece at the measuring workstation,
wherein the at least one property includes at least one of planarity and roughness,
wherein the machine is operative to change a position of the tool by the electrical actuator at the machining workstation in machining subsequent workpieces to meet the required tolerance specifications in response to the at least one property of the machined surface sensed at the measuring workstation.

25. The apparatus according to claim 24
wherein the machine further includes an evaluation unit,
wherein the evaluation unit is in operative connection with the interferometer,
wherein the evaluation unit is operative to determine at least one of a direction and an order of magnitude of movement of change to the position of the electrical actuator.

26. The apparatus according to claim 25
wherein the machining workstation includes at least one of a tool slide and a tool carriage,
wherein the tool is operative to move relative to and in engaged relation with the workpiece at the machining workstation in operative supported connection with the at least one of the tool slide and the tool carriage,
wherein the electrical actuator is operative to change an angle of attack of the tool relative to the workpiece.

27. The apparatus according to claim 25
wherein the electrical actuator is operative to change orientation of the tool relative to the workpiece at the machining workstation as the workpiece undergoes machining at the machining workstation.

28. A method comprising:
operating a machine to machine workpieces that have associated required tolerance specifications that workpieces must meet after machining, the machine including:
a table, wherein the table is rotatably movably mounted on the machine,
a clamp, wherein the clamp
is in operative connection with the table,
is operable to hold a workpiece in engaged relation with the clamp, and
is rotatably movable relative to the table,
wherein the table is rotatable to move the workpiece in engagement with the clamp to at least three disposed workstations on the machine,
the method including:
a) engaging a surface of the workpiece with a tool at a first workstation to machine a surface of the workpiece,
wherein the tool is moved during machining of the surface of the workpiece at the first workstation by a feed unit,
wherein the first station includes an alignment unit, wherein the alignment unit is in operative connection with the tool and is selectively movable responsive to at least one electrical actuator to change orientation of the tool relative to the workpiece during machining of the surface at the workstation,
b) moving the workpiece though movement of the table to a second workstation subsequent to machining of the surface workpiece at the first workstation,
c) cleaning the workpiece at the second workstation with at least one of a laser and a CO₂ snow jet to remove at least one of coolant and lubricant residue from the workpiece,
d) moving the workpiece to a third workstation subsequent to cleaning of the workpiece at the second workstation,
e) determining at least one optical property of the machined surface of the workpiece at the third workstation through operation of an interferometer,
f) operating the electrical actuator in response to the determined at least one optical property to change orientation of the tool relative to at least one workpiece subsequently machined at the first workstation to cause such at least one subsequently machined workpiece to comply with the required tolerance specifications.

29. The method according to claim 28 and further comprising:
operating an evaluation unit using the determined optical property, to calculate at least one of a direction and an order of magnitude of electrical actuator movement to cause the at least one subsequently machined workpiece to comply with required tolerance specifications,
wherein in (f) the electrical actuator is operative to move at least one of the direction and by the order of magnitude responsive to the calculation by the evaluation unit.

30. The method according to claim 29
wherein in (e) the at least one optical property determined includes at least one of planarity and roughness.
